(19) United States
(12) Patent Application Publication
(10) Pub. No.: US 2009/0115634 A1
(43) Pub. Date: May 7, 2009

(54) VEHICLE DETECTING SYSTEM BASED ON GROUND SENSE COIL

(75) Inventor: Zhilong LIANG, Beijing (CN)

Correspondence Address: YING CHEN;Chen Yoshimura LLP, 255 S. GRAND AVE., # 215, LOS ANGELES, CA, 90012, US

(73) Assignee: AOCHENGTONGLI S&T DEVELOPMENT ( BEIJING ) CO., LTD, Beijing (CN)

(21) Appl. No.: 11/964,020

(22) Filed: Dec. 25, 2007

(30) Foreign Application Priority Data
Nov. 7, 2007 (CN) 200710166206.1

(51) Int. Cl. G08G 1/01; G08G 1/042

(52) U.S. Cl. 340/941

(57) ABSTRACT

This invention relates a vehicle detecting system based on ground sense coil, mainly comprising a sense coil and a vehicle detector. The ground sense coil possesses a driving and detecting unit while the vehicle detector has central processing unit (CPU). The drive, the detecting unit and the CPU own separate power supply circuits, there are filter circuits on the input terminal of the CPU and/or on the input terminals of the drive as well as the detecting unit, and common input terminal used to connect external power supply circuit. A voltage regulator circuit can be employed on the power supply circuit of the CPU and will be placed in the same electromagnetic shielding shell with the CPU. This invention has simple structure, is convenient to use and effectively avoids interference of the ground sense coil to the CPU. This invention can be applied on roads or other locations that the vehicles pass to detect the vehicles as well as the traffic condition.

### BACKGROUND OF THE INVENTION

1. Field of the Invention

This invention concerns a vehicle detecting system, based on ground sense coil, which can be applied on roads or other locations that the vehicles pass to detect the vehicles as well as the traffic condition.

2. Description of the Related Art

A vehicle detecting method based on ground sense coil is to bury ground sense coils under the crossings where need identifying and detecting vehicles. Usually two sense coils will be buried under each roadway with spaces and the output signals will be sent to the vehicle detector. When a vehicle runs over the coil, the output signals will be changed, which will make the vehicle identified by the detector, and through the time the vehicle running over the two coils, its running speed will be worked out; through the statistic calculation of the vehicle number and the speed, the vehicle flow, average speed and other traffic data will be given out to judge if this vehicle is speeding or abnormal stopping; through the logical calculation of the red lights, whether this vehicle has gone through a red light can be given out and etc. This ground sense coil gets driving and detecting unit and this unit is the mating circuit of the coil LC vibration circuit, which can induce self vibration of the sense coil to realize detecting vehicle. The CPU in this vehicle detector can carry out relevant calculation and control.

Under the present technique, the coil drive and the detecting share the same power supply circuit as well as the CPU, that is, both of their DCM input terminals are paralleled to the output terminal of the same power supply circuit. Under such power supplying, the ground sense coil has serious effect on the CPU. A signal interference pulse burst will be generated by the ground sense coil when a vehicle passing and the interference range is decided by the size of the vehicle, its shape and whether there is any vehicle passing the surrounding roadways. When the range reaches certain extent, it may arouse great fluctuation of the CPU, which may result in CPU abnormity, affects its stability, even breakdown and causes great inconvenience to the operation and maintenance of the traffic detecting system.

### SUMMARY OF THE INVENTION

This invention concerns a vehicle detecting system, based on ground sense coil, including sense coil and vehicle detector. The ground sense coil possesses driving and detecting unit while the vehicle detector has central processing unit (CPU). The drive; the detecting unit and the CPU own separate power supply circuit, there are filter circuits on the input terminal of the CPU and/or on the input terminals of the drive as well as the detecting unit, and common input terminal used to connect external power supply circuit. A voltage regulator circuit can be employed on the power supply circuit of the CPU and will be placed in the same electromagnetic shielding shell with the CPU. This invention has simple structure, is convenient to use and effectively avoids interference of the ground sense coil to the CPU. This invention can be applied on roads or other locations that the vehicles pass to detect the vehicles as well as the traffic condition.

To overcome the deficiency of the above technique, this invention offers a vehicle detecting system, based on ground sense coil. The CPU of this system will not be interfered by the low frequency vibration signal, with good stability and there will be no breakdown caused by the interference of the sense coil.

The technical plan of the above invention is: a vehicle detecting system, based on ground sense coil, including sense coil and vehicle detector. The ground sense coil possesses driving and detecting unit while the vehicle detector has central processing unit (CPU). The drive, the detecting unit and the CPU own separate power supply circuit.

The effective result of this invention is: The drive, the detecting unit and the CPU own separate power supply circuit, and a filter circuit can be placed between the input terminals of the two power supply circuits, which effectively isolates the low frequency vibration signal, avoids the ground sense coil interfering the CPU and makes sure the CPU operating stably.

### BRIEF DESCRIPTION OF THE DRAWINGS

FIG. 1 shows the schematic diagram of the system power circuit in this invention;

FIG. 2 shows the circuit schematic diagram of the input terminal from the system power circuit in FIG. 1;

FIG. 3 shows the circuit schematic diagram of the intermediate converting circuit from the system power circuit in FIG. 1;

FIG. 4 shows the schematic diagram of the filter circuit between the power circuit of the drive & the detecting unit and that of the CPU from the system power circuit in FIG. 1;

FIG. 5 shows the schematic diagram of the power circuit of the drive & the detecting unit from the system power circuit in FIG. 1;

FIG. 6 shows the schematic diagram of the power circuit of the CPU from the system power circuit in FIG. 1.

### DETAILED DESCRIPTION OF THE PREFERRED EMBODIMENTS

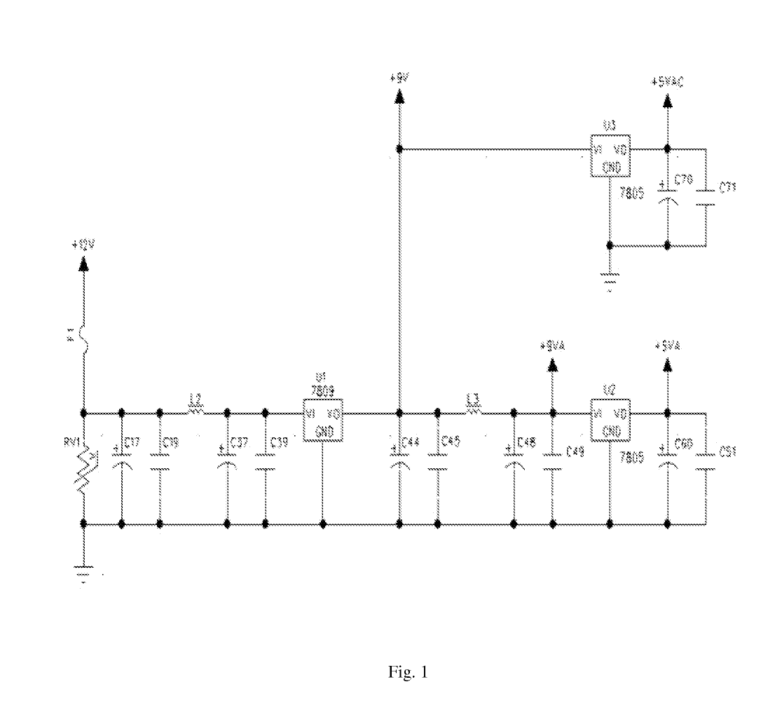

See FIG. 1-6, this invention offers a vehicle detecting system, based on ground sense coil, including sense coil and vehicle detector. The ground sense coil possesses driving and detecting unit while the vehicle detector has central processing unit (CPU). The drive, the detecting unit and the CPU own separate power supply circuit

There can be filter circuit and back voltage regulator circuit or other voltage regulator circuit in the power circuit of the CPU. The filter circuit can isolate external interference waves as the one produced by the sense coil and the voltage regulator circuit can realize the stability of the voltage to make the CPU operating stably.

The CPU power circuit will be placed in the same electromagnetic shielding shell with the CPU to avoid the interference of the external electromagnetic wave and realize compact structure.

The power circuit of the drive & the detecting unit and that of the CPU can connect to different external powers (namely completely separate) and different power supplying can avoid counter influence of the two power circuits; they also can share one external power separately with a common input terminal and sharing one external power circuit is good for simplifying the general structure. (This external power circuit can contain several components and also can common connecting terminals or other connecting components, which is depended by the condition of the external power.)

When the power circuit of the drive & the detecting unit and that of the CPU share one external power circuit, the entire power circuit includes the external power supply circuit, that of the drive & the detecting unit and that of the CPU while the input terminal of the power circuit of the drive & the detecting unit and that of the CPU are connected to the output terminal of the external power circuit respectively and there is filter circuit placed between the power circuit of the drive & the detecting unit and that of the CPU to remove interference signals generated by the sense coil. The filter circuit can be placed either on the input terminal of the power circuit of the drive & the detecting unit, or on that of the CPU, or there are different filter circuits on the input terminal of the power circuit of the drive & the detecting unit and on that of the CPU to improve the filtering effect.

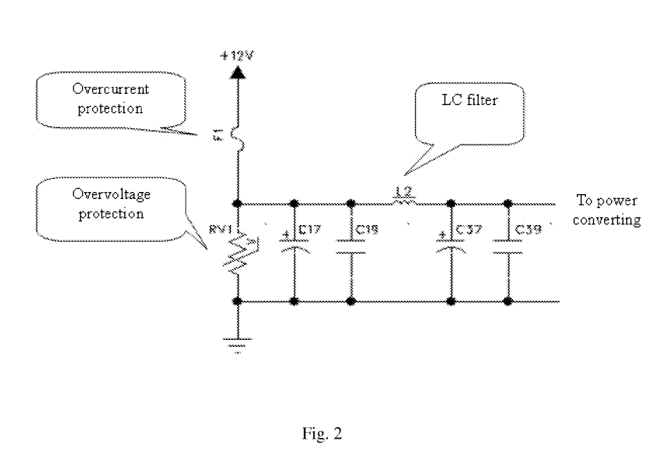

See FIG. 1 and FIG. 2, there are self-restoring fuse (F1) and parallel varistor (RV1) on the input terminal of the external power supply circuit to protect the input power. Meanwhile filter circuit on the input terminal can be placed and this circuit includes several capacitors and inductors (e.g. C17, C19, L2, C37, C39 in FIG. 2) to avoid counter interference

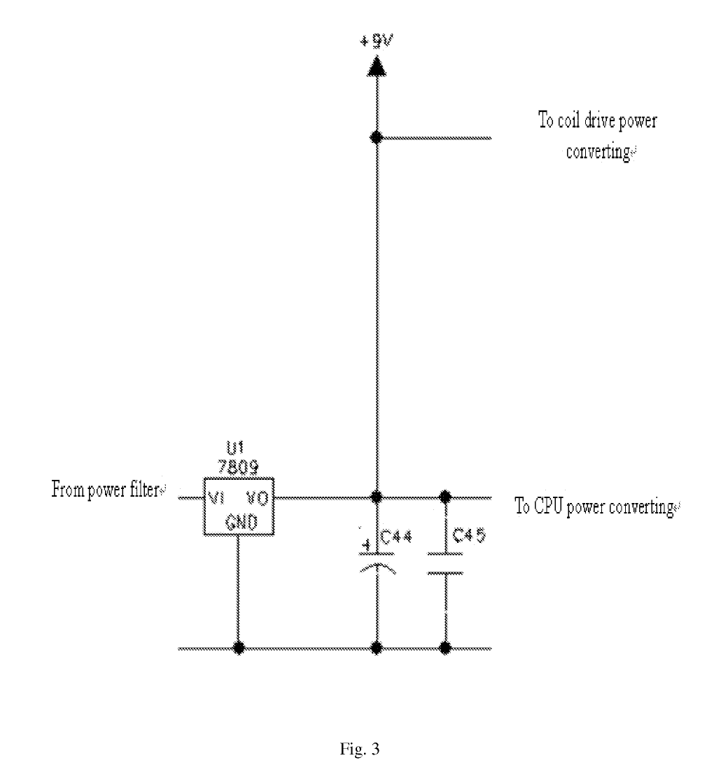

See FIG. 1 and FIG. 3, there can be an intermediate converting circuit (first order) in the external circuit. The input terminal of this intermediate converting circuit is connected to the LC filtering output on the input terminal of the external circuit and the output terminal is the output terminal of the external circuit, connecting the input terminal of the drive and the detecting unit as well as the CPU respectively. 7809 integrated circuit blocks are employed in this converting circuit, which changing the 12V DC external circuit input into 9V DC. The purpose of this intermediate converting circuit is to form second order converting: firstly changing the external input from 12V DC to 9V DC in the external circuit and then the 9V DC will be converted to 5V DC by the power circuit of the drive & the detecting unit and that of the CPU, which can prevent producing lots of heat by direct converting to burn down the power chip. If required voltage is close to the input one, it can directly process on the later power circuit without intermediate converting circuit.

See FIG. 6, the power supply circuit of the drive and the detecting unit is made up of 7805 integrated circuit blocks and its input terminal is connected to the output terminal of the external circuit while its output terminal is paralleled several capacitors (e.g. C70 and C71 in FIG. 6) to improve output quality.

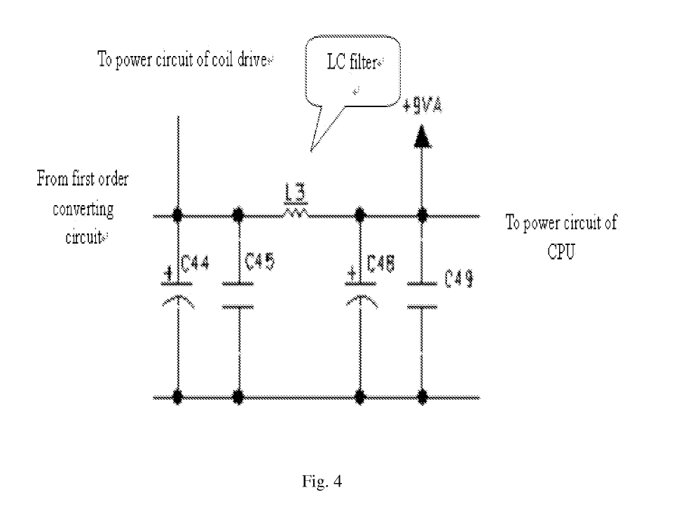

See FIG. 4, filter circuit can be placed between the output terminal of the external circuit and the input of the CPU power circuit and this circuit includes several capacitors and inductors (e.g. C44, C45, L3, C48, C49 in FIG. 4) connected (series and parallel) under present technique. This filter circuit locates between the input terminal of the power circuit of the drive & the detecting unit and that of the CPU, which forms the filter circuit between the input terminal of the power circuit of the drive & the detecting unit and that of the CPU.

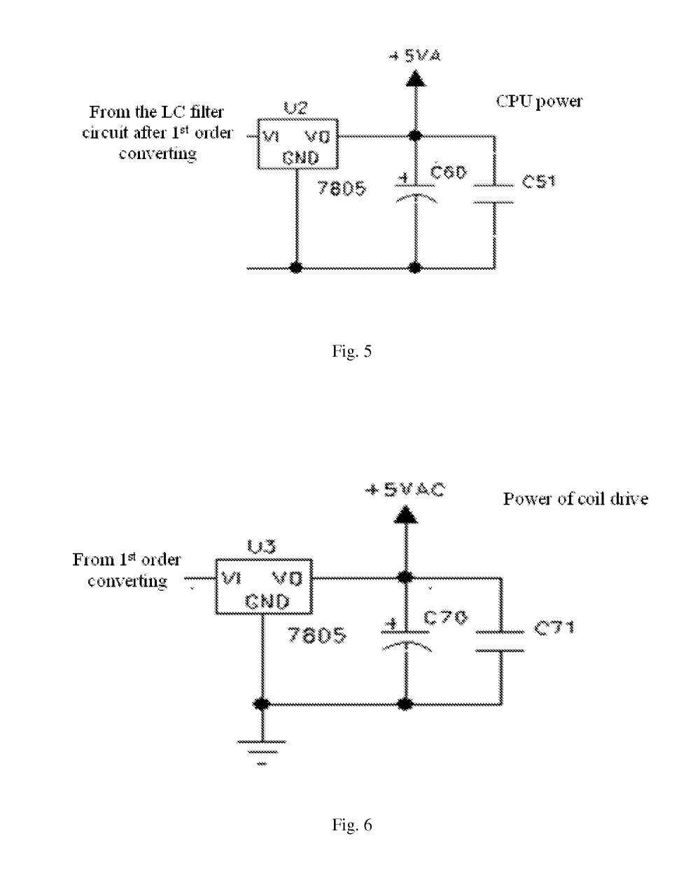

See in FIG. 5, the power supply circuit of the CPU is made up of 7805 integrated circuit blocks and its input terminal is connected to the filter circuit of the external circuit while its output terminal is paralleled several capacitors (e.g. C50 and C51 in FIG. 6) to improve output quality.

There is Watchdog Timer in the vehicle detector, which is generated shortly after the breakdown of the computer by interference and will send enabling signal to the CPU. Then even if there is accidental breakdown, the CPU can be restarted in a short time to realize work condition restoring. This Watchdog Timer can be realized through present technique.

Actually the electronic police system is usually made up of several vehicles detecting systems based on ground sense coil and while fulfilling operating effect and convenience, usually there are more than one (e.g. two on the adjacent roadways) sharing one system power circuit, that is, there are two or more grand sense coils driving and detecting unit loads paralleled on the same output terminal of the power supply circuit of the drive and the detecting unit; there are two or more CPU loads paralleled on the same output terminal the CPU power supply circuit to simplify the general structure and reduce cost.

What is claimed is:

1. A vehicle detecting system based on ground sense coil, said detecting system including a ground sense coil and a vehicle detector, said sense coil comprising a driving and detecting unit, said vehicle detector comprising a central processing unit (CPU), said driving and detecting unit and said CPU owning separate power supply circuit.

2. The vehicle detecting system of claim 1, wherein said CPU and driving and detecting unit have a filter circuits on their input terminals.

3. The vehicle detecting system of claim 2, wherein the power supply circuit of said CPU has a voltage regulator circuit which is placed in the same electromagnetic shielding shell with said CPU.

4. The vehicle detecting system of claim 1, wherein the power supply circuit of said driving and detecting unit and the power supply circuit of said CPU have a common input terminal used to connect external power supply circuits.

5. The vehicle detecting system of claim 2, wherein the power supply circuit of said driving and detecting unit and the power supply circuit of said CPU have a common input terminal used to connect external power supply circuits.

6. The vehicle detecting system of claim 3, wherein the power supply circuit of said driving and detecting unit and the power supply circuit of said CPU have a common input terminal used to connect external power supply circuits.

7. The vehicle detecting system of claim 6, wherein a self-restoring fuse is connected in the input terminal of said external power supply circuit in series and a varister is connected in the input terminal of said external power supply circuit in parallel.

8. The vehicle detecting system of claim 7, wherein said external power supply circuit has a filter circuit on its input terminal.

9. The vehicle detecting system of claim 8, wherein said external power supply circuit has an intermediate converting circuit comprising a 7809 IC block.

10. The vehicle detecting system of claim 9, wherein said intermediate converting circuit's input terminal connects a LC filtering output in the input terminal of said external supply circuit, and its output terminal connects input terminals of the driving and the detecting unit and CPU respectively.

11. The vehicle detecting system of claim 10, wherein said supply circuit of said driving and and detecting unit is made up of 7805 integrated circuit blocks and its input terminal is connected to the output terminal of the external circuit while its output terminal is paralleled several capacitors.

12. The vehicle detecting system of claim 10, wherein there is a filter circuit between the output terminal of the external power circuit and the input terminal of the CPU power supply circuit, said filter circuit is made up of several capacitors and inductors, which form the filter circuit between the power supply circuit of the drive and the detecting unit and the one of the CPU, said CPU power supply circuit is mainly made up of 7805 integrated circuit blocks and its input terminal is connected to the filter circuit on the output terminal of the external circuit while its output terminal is paralleled several capacitors.

13. The vehicle detecting system of claim 1, wherein said system has a watchdog timer, which is generated shortly after the breakdown of the computer by interference and will send enabling signal to the CPU.

14. The vehicle detecting system of claim 2, wherein said system has a watchdog timer, which is generated shortly after the breakdown of the computer by interference and will send enabling signal to the CPU.

15. The vehicle detecting system of claim 3, wherein said system has a watchdog timer, which is generated shortly after the breakdown of the computer by interference and will send enabling signal to the CPU.

16. The vehicle detecting system of claim 15, wherein two or more grand sense coils of driving and detecting unit loads paralleled on output terminal of said power supply circuit, two or more CPU load paralleled on the output terminal the CPU power supply circuit.

17. The vehicle detecting system of claim 16, wherein two or more grand sense coils of driving and detecting unit loads paralleled on output terminal of said power supply circuit, two or more CPU load paralleled on the output terminal the CPU power supply circuit.

18. The vehicle detecting system of claim 17, wherein two or more grand sense coils of driving and detecting unit loads paralleled on output terminal of said power supply circuit, two or more CPU load paralleled on the output terminal the CPU power supply circuit.

19. The vehicle detecting system of claim 18 wherein two or more grand sense coils of driving and detecting unit loads paralleled on output terminal of said power supply circuit, two or more CPU load paralleled on the output terminal the CPU power supply circuit.
